(19) United States
(12) Patent Application Publication
(10) Pub. No.: US 2026/0054398 A1
(43) Pub. Date: Feb. 26, 2026

(54) FOLDING KNIFE

(71) Applicant: Hangzhou Great Star Industrial Co., Ltd., Hangzhou City (CN)

(72) Inventor: Yongwei Zhu, Hangzhou City (CN)

(73) Assignee: Hangzhou Great Star Industrial Co., Ltd., Hangzhou City (CN)

(21) Appl. No.: 19/268,576

(22) Filed: Jul. 14, 2025

Related U.S. Application Data
(63) Continuation-in-part of application No. PCT/CN2025/077291, filed on Feb. 14, 2025.

(30) Foreign Application Priority Data
Feb. 18, 2024 (CN) 202420297531.0
Jul. 16, 2024 (CN) 202410951202.8
Jul. 16, 2024 (CN) 202421680374.8

(51) Int. Cl. B26B 1/04; B26B 1/08; B26B 5/00

(52) U.S. Cl. CPC B26B 1/046; B26B 1/08; B26B 5/006

(57) ABSTRACT

A folding knife includes a grip portion, a working portion, a translation mechanism and a first locating structure. The grip portion defines an accommodating hollow therein, and the working portion includes a blade and a mounting support. The mounting support is able to pivot about the grip portion to switch between an unfolded position and a folded position. When the mounting support is in the unfolded position, a free end of the mounting support is located in front of the grip portion. When the mounting support is in the folded position, the free end of the mounting support is located in the accommodating hollow. When the mounting support is in the folded position, the translation mechanism is able to move in a lengthwise direction of the grip portion, causing the blade to move relative to the grip portion between the extended and retracted positions. The first locating structure is able to locate the blade in the extended and retracted positions.

### RELATED APPLICATIONS

This application is a continuation-in-part (CIP) application claiming benefit of PCT/CN2025/077291 filed on Feb. 14, 2025, which claims priorities to Chinese Utility Model application No. 202420297531.0 filed on Feb. 18, 2024, Chinese Utility Model application No. 202421680374.8 filed on Jul. 16, 2024, and Chinese Patent Application No. 202410951202.8 filed on Jul. 16, 2024, the disclosures of which are incorporated herein in their entirety by reference.

### FIELD OF THE INVENTION

The present application relates to the field of hand tools, and particularly to a multi-purpose folding knife.

### DESCRIPTION OF THE PRIOR ART

To date, a folding knife can be used for cutting only after its blade assembly has been unfolded. However, when the folding knife is held in a hand and it is inconvenient to unfold the blade assembly, it would be difficult to use it to cut anything. Additionally, for some straightforward cutting tasks, it may be considered cumbersome to unfold the blade assembly. Furthermore, during unfolding of the blade assembly, the edge will be increasingly exposed as it is being pivoted, creating potential safety hazards.

### SUMMARY OF THE INVENTION

In view of the above-described shortcomings of the prior art, the problem sought to be solved by the present application is that conventional folding knives can be used for cutting only when its blade assembly is unfolded.

To this end, the present application provides a folding knife, comprising:
a grip portion defining an accommodating hollow therein and, in a lengthwise direction thereof, a front end and a rear end;
a working portion comprising a blade and a mounting support, the blade disposed on the mounting support, the mounting support having a fixed end and a free end, the fixed end of the mounting support disposed on the grip portion, the free end of the mounting support configured to be pivotable about the grip portion to switch between an unfolded position and a folded position, wherein when the mounting support is in the unfolded position, the free end of the mounting support is located in front of the grip portion, and when the mounting support is in the folded position, the free end of the mounting support is located in the accommodating hollow;
a translation mechanism configured, when the mounting support is in the folded position, to be movable in the lengthwise direction of the grip portion, thereby driving the blade to move relative to the grip portion to switch between an extended position and a retracted position, wherein when the blade is in the extended position, at least part thereof extends out of the accommodating hollow from the rear end, and when the blade is in the retracted position, it is located in the accommodating hollow; and
a first locating structure configured to be able to locate the blade in the extended position and the retracted position.

Additionally, the folding knife may have a first working configuration, a second working configuration and a stowed configuration, wherein when the folding knife is in the first working configuration, the mounting support is in the unfolded position, and the blade is partially exposed outside the mounting support; when the folding knife is in the second working configuration, the mounting support is in the folded position, and the blade is in the extended position; and when the folding knife is in the stowed configuration, the mounting support is in the folded position, and the blade is in the retracted position.

Additionally, the grip portion may define at the rear end thereof a wide opening in communication with the accommodating hollow, wherein when the folding knife is in the second working configuration, the blade partially extends through the wide opening.

Additionally, a stopper may be disposed on the grip portion and configured to be movable relative to the wide opening to a stopping position, where it occludes the wide opening, confining the blade within the accommodating hollow.

Additionally, the stopper and the grip portion may define complementary second locating structures configured to be able to locate the stopper in the stopping position.

Additionally, the translation mechanism may comprise a moving member disposed within the accommodating hollow, the moving member defining a compartment, which forms part of the accommodating hollow, wherein the fixed end of the mounting support is coupled to the moving member; the blade is mounted on the mounting support and partially exposed outside the mounting support; the free end of the mounting support is configured to be pivotable about the moving member to switch between the unfolded position and the folded position; when the mounting support is in the folded position, the free end of the mounting support is located within the compartment; and the moving member is configured to be moveable within the accommodating hollow in the lengthwise direction of the grip portion, driving the mounting support to move relative to the grip portion.

Additionally, inner walls of the grip portion may define a slide channel extending in the lengthwise direction of the grip portion, wherein the moving member is disposed in the slide channel.

Additionally, the grip portion may define an elongate slot extending in the lengthwise direction of the grip portion, wherein the first locating structure comprises a first locating recess and a second locating recess, which are arranged along the elongate slot in the lengthwise direction of the grip portion sequentially from the front backwards; the translation mechanism further comprises a manipulation means disposed on the moving member and exposed outside the grip portion through the elongate slot, the manipulation means configured to be movable in the elongate slot, driving movement of the moving member; when the manipulation means is located at the first locating recess, the moving member is in a first position; and when the manipulation means is located at the second locating recess, the moving member is in a second position.

Additionally, when the mounting support is in the folded position, the first position may be the retracted position, and the second position may be the extended position.

Additionally, the first locating structure may further comprise a third locating recess located between the first and second locating recesses.

Additionally, the mounting support may define locking recesses, wherein the moving member is provided with a locking rod exposed outside the grip portion through the elongate slot, the locking rod configured to be axially movable to switch between a rotation-disabling position and rotation-enabling position; when the locking rod is in the rotation-disabling position, the locking rod engages in one of the locking recesses, disallowing pivoting of the mounting support; and when the locking rod is in the rotation-enabling position, the locking rod disengages from the locking recess, allowing the mounting support to pivot.

Additionally, the moving member may define a resilient portion; the grip portion defines an avoidance slot in its inner wall, wherein when the moving member is in the first position, and when the locking rod is in the rotation-enabling position, the locking rod abuts against the resilient portion, and the resilient portion is aligned with the avoidance slot.

Additionally, the locking rod may axially extend through the moving member, wherein the grip portion defines a blind hole in its inner wall, and when the moving member is in the first position, the locking rod points toward the blind hole.

Additionally, when the locking rod is in the rotation-enabling position, the locking rod may be able to move into the blind hole, blocking the moving member from movement.

Additionally, the locking recesses may include a first locking recess and a second locking recess, wherein when the mounting support is in the unfolded position, the locking rod engages in the first locking recess; and when the mounting support is in the folded position, the locking rod engages in the second locking recess.

Additionally, the folding knife may further comprise a resilient element disposed between the mounting support and the moving member, the resilient element configured, when the mounting support is in the folded position, and when the locking rod is in the rotation-enabling position, to be able to switch the mounting support to the unfolded position.

Additionally, the mounting support may define a shoulder, which, when the mounting support is in the unfolded position, abuts against the grip portion and is configured to be able to block movement of the moving member in the lengthwise direction of the grip portion.

Additionally, the translation mechanism may comprise an inner holder member and a manipulation means, wherein the inner holder member is disposed on the mounting support, and the blade is disposed on the inner holder member; and the manipulation means is coupled to the inner holder member, exposed outside the mounting support and configured to be movable in a lengthwise direction of the mounting support, thereby causing the inner holder member to move relative to the mounting support.

Additionally, the first locating structure may comprise a plurality of locating recesses sequentially arranged from the front backwards in the mounting support in the lengthwise direction thereof, wherein the manipulation means is configured to be able to be located in any of the locating recesses; when the manipulation means is located in a frontmost one of the locating recesses, the blade is in the extended position; and when the manipulation means is located in a rearmost one of the locating recesses, the blade is in the retracted position.

Additionally, the inner holder member may be provided with a blade lock configured to be able to lock the blade against the inner holder member, wherein the mounting support is provided with an unlocking means; and when the blade is in the extended position, the unlocking means is aligned with the blade lock and configured to be able to abut against the blade lock to disengage the blade from the inner holder member.

In one aspect of the present application, it seeks to solve the problem that conventional folding knives can be used for cutting only when the blade assembly has been unfolded by presenting a folding knife allowing a blade to be extended out for use in a folded and stowed configuration thereof.

To this end, the present application provides a folding knife, comprising:
a handle defining an accommodating cavity, the accommodating cavity defining a wide opening at a rear end thereof; and
a blade assembly assembled to a front portion of the handle through a pivotal shaft so as to be able to fold into or out of the accommodating cavity, the blade assembly comprising a blade holder and a blade movably disposed on the blade holder, wherein when the blade assembly folds into the accommodating cavity, the blade is able to be stowed in the accommodating cavity, or extended out of the handle for use through the wide opening of the accommodating cavity.

In this folding knife, through providing the wide opening at the rear end of the accommodating cavity, when the blade assembly folds into the accommodating cavity, the blade can be either stowed in the accommodating cavity, or extended out of the handle for use through the wide opening of the accommodating cavity. With this arrangement, when the folding knife is held in a hand and it is inconvenient to unfold the blade assembly, the blade can be extended out of the handle to perform some simple cutting tasks, without needing to unfold the blade assembly.

Additionally, in order to prevent the blade from accidentally extending out of the handle and thus creating potential safety hazards due to the presence of the wide opening, a stopper movable between a stopping position and an avoidance position may be provided at the wide opening. When in the stopping position, the movable stopper blocks the blade from extending out of the handle through the wide opening of the accommodating cavity. When in the avoidance position, the movable stopper avoids affecting the extension of the blade out of the accommodating cavity of the handle through the wide opening. With this arrangement, the movable stopper can be switched between different positions to block the blade from extending out of the handle through the wide opening of the accommodating cavity, or not.

Additionally, the movable stopper and the handle may define complementary first locating structures, which can locate the movable stopper in both the stopping and avoidance positions, avoiding its accidental displacement.

Specifically, the first locating structures may comprise locating recesses and locating protrusions separately provided in and on the movable stopper and the handle. The stopper can be located when any of the locating protrusions is received in a respective one of the locating recesses.

In particular, for ease of operation, the movable stopper may be rotatably assembled to the handle so that the movable stopper can be pushed or pulled with a hand to switch between the positions.

Additionally, the blade holder may comprise an outer holder member, an inner holder member and a manipulation means, the inner holder member slidably disposed in the outer holder member, the manipulation means coupled to the inner holder member and exposed outside the outer holder member so as to be able to be manipulated to drive movement of the inner holder member, wherein the blade is assembled to the inner holder member. With this arrangement, the inner holder member can be moved as needed by manipulating the manipulation means.

Additionally, the outer holder member may define a number of locating recesses spaced in a forward-and-backward direction, wherein the manipulation means may be located in any of the locating recesses to immobilize the blade at a corresponding position. With this arrangement, the blade can be located at different positions to address various cutting needs.

In particular, a first resilient element may be arranged between the inner holder member and the manipulation means to bias the manipulation means into one of the locating recesses, avoiding accidental displacement of the blade during cutting.

In order to facilitate replacement of the blade, the inner holder member may be provided with a locking means for locking the blade against the inner holder member, wherein the outer holder member is provided with an unlocking means, which allows the locking means to be unlocked when the inner holder member moves forward into alignment of the locking means with the unlocking means.

In order to reliably lock the blade against the inner holder member, the locking means may be pivotably assembled to the inner holder member, wherein magnetic steel is provided on the inner holder member to provide an attractive force that attaches the blade and the locking means to the inner holder member, and the unlocking means is configured to be laterally pressed to unlock the locking means.

According to the present application, through providing the wide opening at the rear end of the accommodating cavity, when the blade assembly folds into the accommodating cavity, the blade can be either stowed in the accommodating cavity, or extended out of the handle for use through the wide opening of the accommodating cavity. With this arrangement, when the folding knife is held in a hand and it is inconvenient to unfold the blade assembly, the blade can be extended out of the handle to perform some simple cutting tasks, without needing to unfold the blade assembly. This adds flexibility to use of the folding knife.

In another aspect of the present application, it seeks to overcome the problem that use of conventional folding knives involves unfolding the cutter by pivoting it, which is cumbersome and associated with potential safety hazards due to exposure of the cutting edge during the pivoting by presenting a folding knife allowing a cutter in a folded configuration to be extended out of a handle for use. This enables the folding knife to be used in multiple modes, adding convenience of use. Additionally, exposure of a cutting edge during pivoting can be avoided in some of the modes, reducing potential safety hazards.

To this end, the present application provides a folding knife, comprising:
a handle defining a stowing space extending between first and second ends thereof;
a moving member received in the handle, the moving member configured to move between the first and second ends;
second locating structures provided on the handle and the moving member, the second locating structures configured to locate the moving member during its movement in at least first and second positions on the handle; and
a cutter pivotably coupled to the moving member so as to be fold into the stowing space from an unfolded configuration, or out of the stowing space from a folded configuration, wherein when the cutter is in the folded configuration, the moving member can be moved from the first end to the second end and located at the second position where the cutter is extended out of the second end and available for use, or the moving member can be moved from the second end to the first end and located at the first position where the cutter is retracted into the stowing space from the second end.

With this arrangement, the folding knife can be used in a first mode, in which the cutter can be pivoted to fold out from the handle for use, or fold into the handle for stowing, or in a second mode, in which the folded cutter can be moved out of the handle for use, or back into the stowing space. This allows the folding knife to be used in multiple modes, and in the second mode, the cutter is translated out of and back into the handle, instead of being pivoted as in the first mode. This enables more convenient operation. Moreover, the cutter can be gradually extended out of the handle, with its cutting edge being fixed in orientation, effectively reducing potential safety hazards.

Additionally, the moving member may comprise a first side wall and a second side wall, which are connected at their edges by a connecting feature and define therebetween a compartment, wherein the compartment forms part of, and is oriented in the same way as, the stowing space, and a pivotal shaft is coupled between the first and second side walls. With this arrangement, the moving member is structurally stronger and can be more reliably assembled to the handle. In particular, providing the compartment as part of the stowing space results in a simpler structure.

Additionally, the cutter may be coupled to the moving member through the pivotal shaft, which is concealed within the handle. With this arrangement, the handle maintains a fit and neat appearance, and smooth movement of the moving member can be ensured, without being hindered by the handle.

Additionally, inner walls of the handle may define a track, and movement of the moving member may be accomplished with the aid of the track. This ensures flexibly movability of the moving member and minimizes its wobbling during movement.

Additionally, the handle may define an elongate slot extending between the first and second ends, and arranged along the elongate slot, a first locating recess and a second locating recess, wherein the moving member is provided with a manipulation means, which is exposed outside the handle through the elongate slot and thereby can be manipulated to drive movement of the moving member; the second locating structures include the first locating recess, the second locating recess and the manipulation means; when located at the first locating recess, the manipulation means locates the moving member in the first position; and when located at the second locating recess, the manipulation means locates the moving member in the second position. With this arrangement, the manipulation means can be manipulated to cause the moving member to move, with a hand that is holding the handle, allowing for convenient operation.

Additionally, the cutter may define a locking recess, and an axially movable locking rod may be assembled to the moving member, wherein the locking rod is exposed outside the handle through the elongate slot and thereby can be pressed; the locking rod is biased into the locking recess, locking the cutter and preventing its pivoting; and pressing the locking rod with a force overcoming the bias can unlock the cutter and allows its pivoting. With this arrangement, the locking rod can be used to lock the cutter in a desired configuration, such as any of the folded configuration, the unfolded configuration or a partially unfolded configuration between the folded and unfolded configurations.

Additionally, the moving member may define a resilient portion for providing the bias, wherein an inner end of the locking rod abuts against the resilient portion, and the handle defines, in one of its inner walls, an avoidance slot, which enables deformation of the resilient portion. This results in a simpler structure with fewer components, reducing the effort required to assemble the components. Moreover, it is ensured that the bias can be provided in a reliable way.

Additionally, the locking rod may be axially inserted through the moving member, wherein the handle defines a blind hole in one of its inner walls; when unlocking the cutter and allowing its pivoting by pressing the locking rod with a force overcoming the bias, the inner end of the locking rod is received in the blind hole, blocking the moving member from movement. This prevents displacement of the moving member while the cutter is being pivoted, which may create potential safety hazards. With this arrangement, only one of, but not both, pivoting and translation of the cutter can occur at any time, preventing erroneous operation.

Additionally, the blind hole may be located at a position where the inner end of the locking rod points toward the blind hole when the moving member is located at the first position. With this arrangement, the cutter can be pivoted only when located at a particular position, preventing erroneous operation that may otherwise result from the ability of the cutter to pivot at any position.

Additionally, when folding into the stowing space, the cutter may be locked by the locking rod against pivoting about the pivotal shaft. This can prevent accidental unfolding of the cutter.

Additionally, the cutter may be biased by a fourth resilient element so as to fold out of the stowing space once unlocked from the locking rod. With this arrangement, when the cutter is to be used, it can be unlocked from the locking rod and then automatically fold out under the action of a bias force from the fourth resilient element.

Additionally, the cutter may have a shoulder, wherein when the cutter is in the unfolded configuration, the shoulder is blocked by the handle, preventing the moving member from moving from the first position toward the second position. With this arrangement, the moving member is prevented from driving movement of the cutter when it is in the unfolded configuration, which may lead to an error in operation.

Additionally, the handle may define, at the second end, an opening allowing passage in and out, wherein after the moving member is moved from the first end to the second end and located in the second position, the folded cutter can be extended out of the stowing space for use, while being restricted by the second end of the handle from moving to the unfolded configuration. With this arrangement, when the cutter is extended out of the stowing space, it is prevented from pivoting, thus avoiding erroneous operation.

Additionally, the second locating structure may locate the moving member, during its movement, in a third position on the handle between the first and second positions, wherein when the moving member is located in the third position on the handle, the folded cutter is blocked by the second end from moving toward the unfolded position, and/or a length of the cutter outside the second end is shorter than that when the moving member is located in the second position on the handle. This allows the cutter to be located in more positions during its movement with the moving member, as may be needed.

Additionally, the cutter may be configured so as to be allowed to pivot only when the moving member is located in the first position on the handle, and the moving member may be allowed to move between the first and second ends only when the cutter has folded into the stowing space from the first end. With this arrangement, erroneous operation can be prevented.

Additionally, when the cutter is in the unfolded configuration, its length outside the handle may be adjusted by moving the moving member between the first and second ends. This entails multiple modes of use of the folding knife.

Additionally, pivoting of the cutter and movement of the moving member may be mutually exclusive.

According to the present application, through providing the moving member in the handle and pivotably coupling the cutter to the moving member, the cutter can fold into the stowing space from the unfolded configuration, or out of the stowing space from the folded configuration. Moreover, the second locating structure is provided to locate the moving member at least in the first and second positions on the handle during its movement. With this arrangement, the folding knife can be used in a first mode, in which the cutter can be pivoted to fold out from the handle for use, or fold into the handle for stowing, or in a second mode, in which the folded cutter can be moved out of the handle for use, or back into the stowing space. This allows the folding knife to be used in multiple modes, and in the second mode, the cutter is translated out of and back into the handle, instead of being pivoted as in the first mode. This enables more convenient operation. Moreover, the cutter can be gradually extended out of the handle, with its cutting edge being fixed in orientation, effectively reducing potential safety hazards.

### BRIEF DESCRIPTION OF THE DRAWINGS

FIG. 1 is an axonometric view of a folding knife according to an embodiment of the present application.

FIG. 2 is a schematic orthographic projection view of one side of a folding knife according to an embodiment of the present application.

FIG. 3 is a top view of FIG. 2.

FIG. 4 is a cross-sectional view of FIG. 3, taken along A-A.

FIG. 5 is a schematic exploded view of a handle and a blade assembly in the folding knife of FIG. 1.

FIG. 6 is a schematic structure view of FIG. 5, taken from a different angle.

FIG. 7 is a schematic exploded view of the blade assembly of FIG. 5.

FIG. 8 is schematic structure view of FIG. 7, taken from a different angle.

FIG. 9 schematically illustrates a folding knife in a folded configuration according to the present application, in which a blade extends out of a handle.

FIG. 10 is a schematic cross-sectional view of FIG. 9.

FIG. 11 schematically illustrates a folding knife in a folded configuration according to an embodiment of the present application, in which a blade is received in an accommodating cavity.

FIG. 12 is a schematic cross-sectional view of FIG. 11.

FIG. 13 is an axonometric view of a folding knife in an unfolded configuration according to an embodiment of the present application.

FIG. 14 is a schematic exploded view of a handle in the folding knife of FIG. 13.

FIG. 15 is a schematic structural view of FIG. 14, taken from a different angle.

FIG. 16 shows a schematic orthographic projection of the folding knife of FIG. 13 in a given direction.

FIG. 17 is a left view of FIG. 16.

FIG. 18 is a cross-sectional view of FIG. 17, taken along B-B.

FIG. 19 is an axonometric view of a folding knife in a folded configuration according to an embodiment of the present application, in which a cutter has been retracted back into a stowing space.

FIG. 20 is a schematic exploded view of the folding knife of FIG. 19.

FIG. 21 is a schematic structural view of FIG. 20, taken from a different angle.

FIG. 22 shows a schematic orthographic projection of the folding knife of FIG. 19 in a given direction.

FIG. 23 is a schematic illustration of the folding knife of FIG. 18, in which a cutter has folded into a stowing space.

FIG. 24 is an axonometric view of a folding knife in a folded configuration according to an embodiment of the present application, in which a cutter extends out of a second end thereof.

FIG. 25 is a schematic exploded view of the folding knife of FIG. 24.

FIG. 26 is a schematic structural view of FIG. 25, taken from a different angle.

FIG. 27 shows a schematic orthographic projection of the folding knife of FIG. 24 in a given direction.

FIG. 28 is a schematic illustration of the folding knife of FIG. 23, in which a cutter extends out of a second end thereof.

FIG. 29 is a schematic exploded view of a moving member and a cutter shown in FIG. 15.

FIG. 30 is a schematic cross-sectional view of a folding knife in an unfolded configuration according to an embodiment of the present application.

FIG. 31 schematically illustrates pivoting of a cutter in a folding knife according to an embodiment of the present application.

FIG. 32 is a cross-sectional view of FIG. 31, taken along C-C.

FIG. 33 is a cross-sectional view of FIG. 32, taken along D-D.

FIG. 34 is a schematic illustration of the folding knife of FIG. 31, with a second handle shell thereof having been removed.

FIG. 35 is a schematic illustration of a second handle shell according to an embodiment of the present application.

FIG. 36 is a schematic illustration of a locking member according to an embodiment of the present application.

FIG. 37 schematically illustrates an orthographic projection of a folding knife in a folded configuration according to an embodiment of the present application.

FIG. 38 is a cross-sectional view of FIG. 37, taken along E-E.

FIG. 39 is a schematic illustration of a locking member according to an embodiment of the present application.

### LIST OF REFERENCE NUMERALS

100 handle; 101 first end; 102 second end; 103 stowing space; 104 wide opening; 105 movable stopper; 106 locating recess; 107 locating protrusion; 108 shaft; 109 clip;
110 first handle shell; 111 elongate slot; 112 first locating recess; 113 second locating recess; 114 third locating recess; 115 track;
120 second handle shell; 121 avoidance slot; 122 blind hole;
200 moving member; 201 first side wall; 202 second side wall; 203 connecting feature; 204 compartment; 205 resilient portion;
300 cutter;
310 blade holder; 311 outer holder member; 3111 first holder half; 3112 second holder half; 3113 narrow slot; 3114 locating recess; 312 inner holder member; 3121 magnetic steel; 3122 pocket; 313 manipulation means; 3131 stem; 3132 shoulder; 314 first resilient element; 315 blade lock; 3151 tongue; 3152 force-receiving portion; 316 unlocking means; 317 second resilient element;
320 blade; 321 notch;
301 bump; 302 third resilient element; 303 locking recess; 304 shoulder; 500 pivotal shaft;
600 locking rod; 601 thin section; 602 thick section;
700 fourth resilient element;
3031 first locking recess; 3032 second locking recess; 3033 third locking recess.

### DETAILED DESCRIPTION OF THE PREFERRED EMBODIMENTS

Embodiments of the present invention will be described clearly and fully hereunder in conjunction with the appended drawings so that objects, aspects and advantages of the invention will become more apparent. Evidently, the embodiments set forth herein are merely some but not all possible embodiments of this invention. Any and all other embodiments devisable by skilled artisans in light of the disclosed embodiments without paying any creative effort are considered to fall within the scope of protection of this invention.

As used herein and in the appended claims, the terms “comprises”, “comprising”, “includes”, “including”, “has”, “having”, or any other variation thereof, are intended to cover a non-exclusive inclusion. For example, a method or product that comprises a list of features is not necessarily limited to only those features but may include other features not expressly listed or inherent to such method or product.

It is to be noted that the terms “up”, “down”, “left”, “right”, “front”, “rear” and so on may be used herein to describe orientations or positional relationships as viewed in the annexed figures. They are for convenience and ease of description of the present invention only and do not indicate or imply that the described apparatus or element must assume, or be constructed or operated in, a particular orientation. Therefore, they are not to be construed as limiting the present invention. Each of the pairs of “up” and “down”, “left” and “right” and “front” and “rear” each refers to a pair of opposite directions.

It is to be noted that, the ordinal terms “first”, “second”, etc., may be used herein to describe elements. These terms are only used to illustrate the elements clearly and distinguish one element from another, and are not intended to imply that the elements are so termed in practice. Therefore, they should not be construed as limiting the present invention in any way.

The present invention is described in detail below with reference to the accompanying drawings, which illustrate specific embodiments thereof.

Provided herein is a folding knife, comprising:
a grip portion defining an accommodating hollow therein and, in a lengthwise direction thereof, a front end and a rear end;
a working portion comprising a blade and a mounting support, the blade disposed on the mounting support, the mounting support having a fixed end and a free end, the fixed end of the mounting support disposed on the grip portion, the free end of the mounting support configured to be pivotable about the grip portion to switch between an unfolded position and a folded position, wherein when the mounting support is in the unfolded position, the free end of the mounting support is located in front of the grip portion, and when the mounting support is in the folded position, the free end of the mounting support is received in the accommodating hollow;
a translation mechanism, configured to be movable in the lengthwise direction of the grip portion when the mounting support is in the folded position, thereby driving the blade to move relative to the grip portion to switch between an extended position and a retracted position, wherein when the blade is in the extended position, at least part thereof extends out of the accommodating hollow from the rear end, and the blade is received in the accommodating hollow when in the retracted position; and
a first locating structure, configured to be able to locate the blade in the extended position and the retracted position.

The folding knife has a first working configuration, a second working configuration and a stowed configuration. When the folding knife is in the first working configuration, the mounting support is in the unfolded position, and the blade is partially exposed outside the mounting support. When the folding knife is in the second working configuration, the mounting support is in the folded position, and the blade is in the extended position. When the folding knife is in the stowed configuration, the mounting support is in the folded position, and the blade is in the retracted position.

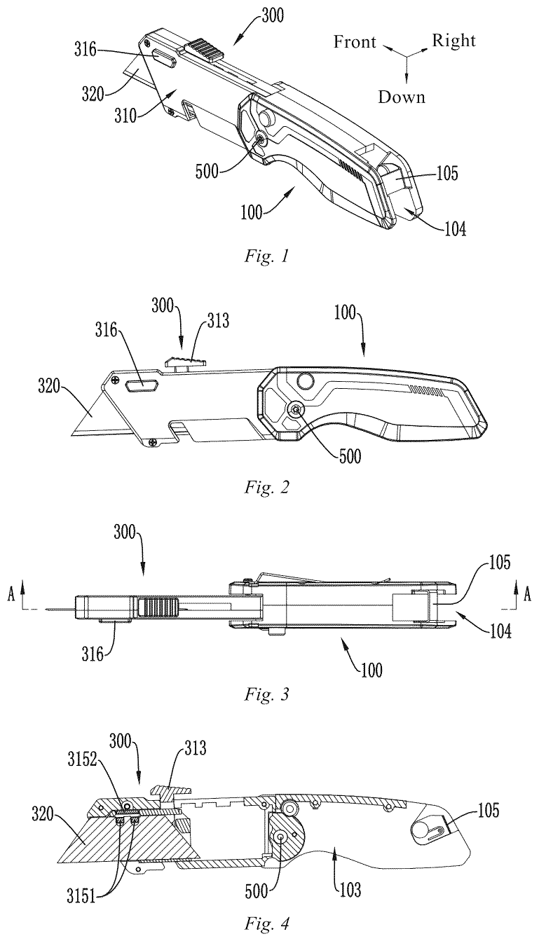

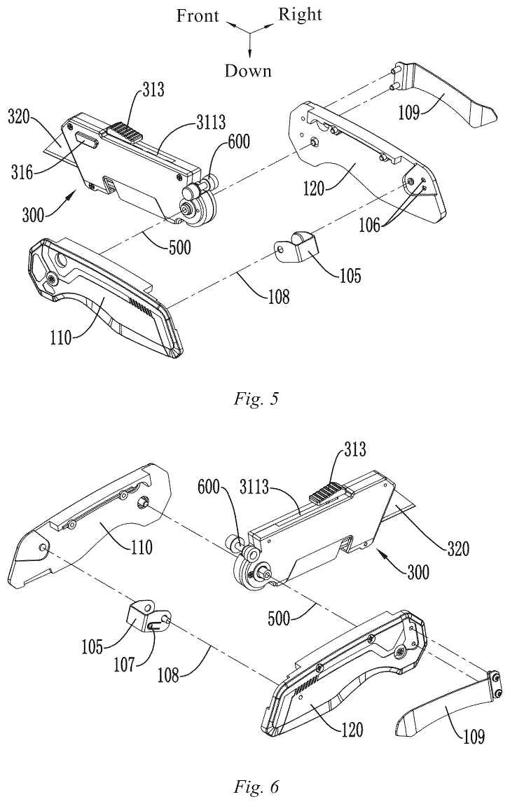

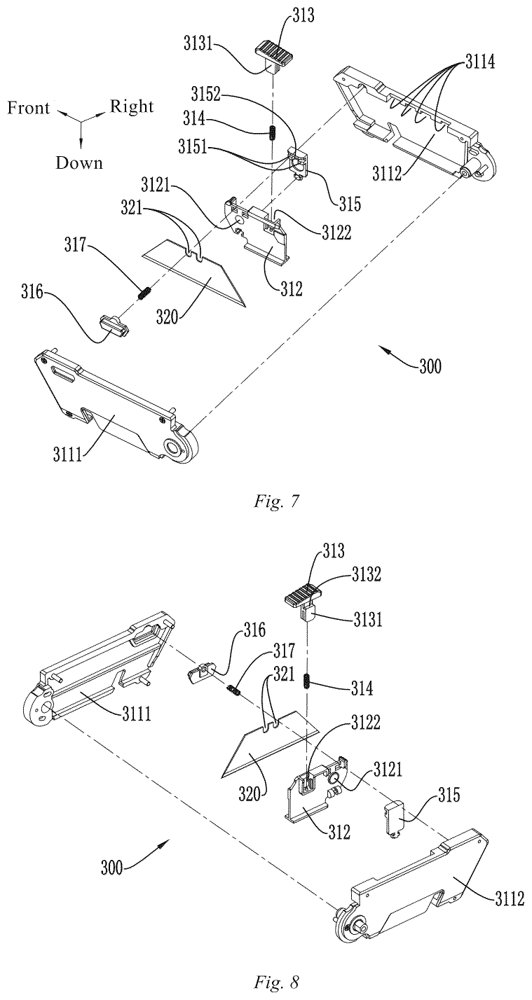

As shown in FIGS. 1 to 6 and 9 to 12, a folding knife according to an embodiment includes a handle 100 and a blade assembly. The blade assembly is also referred to as a cutter 300.

Referring to FIG. 1, when the cutter 300 is in an unfolded configuration, a blade 320 points forward. A rightward direction is defined as pointing from a first handle shell 110 to a second handle shell 120. A downward direction is defined as pointing from the top of the page to the bottom thereof. In FIG. 1, a lengthwise direction of a grip portion and a mounting support is defined as indicated by arrow “Forward”.

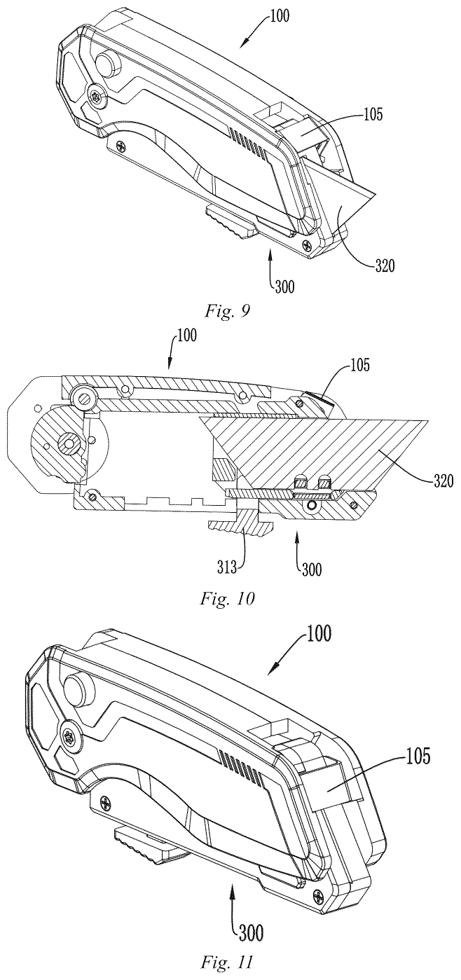

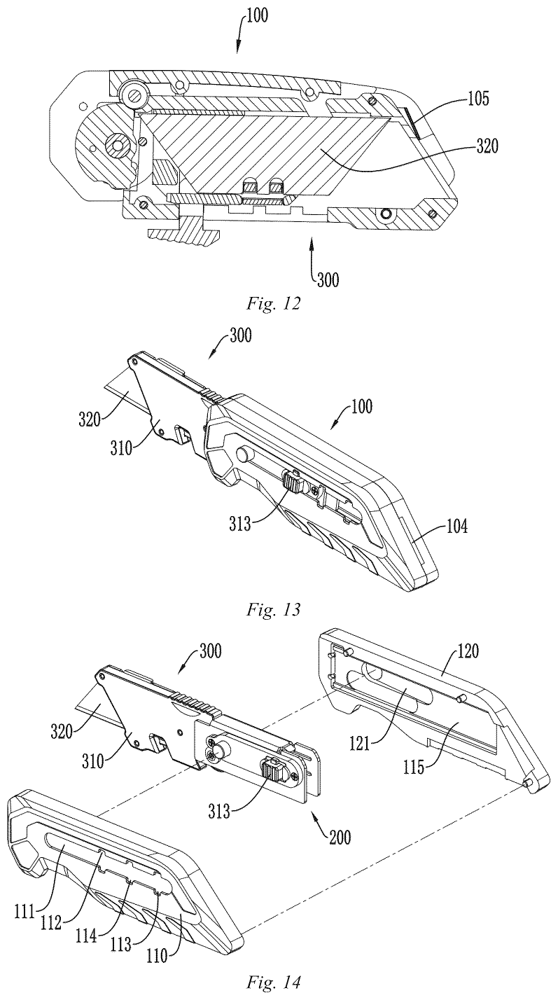

The handle 100 provides the grip portion, which defines a front end and a rear end in the lengthwise direction. The handle 100 is an assembly of the first handle shell 110 and the second handle shell 120. The first handle shell 110 and the second handle shell 120 are spaced from each other at a distance and thereby define therebetween an accommodating cavity serving as a stowing space 103. The stowing space 103 is also referred to as an accommodating hollow. The accommodating cavity defines a wide opening 104 at a rear end thereof, and a movable stopper 105, also referred to simply as a stopper, is disposed at the wide opening 104. The movable stopper 105 is rotatably assembled to the first handle shell 110 and second handle shell 120 through a shaft 108 so as to be pivotable between a stopping position and an avoidance position. The movable stopper 105, when in the stopping position as shown in FIGS. 11 to 12, occludes the wide opening 104 and stops the blade 320 from extending out of the accommodating cavity of the handle 100 through the wide opening 104. As shown in FIGS. 9 to 10, when in the avoidance position, the movable stopper 105 avoids affecting the extension of the blade 320 out of the accommodating cavity of the handle 100 through the wide opening 104. The movable stopper 105 and the handle 100 are provided with complementary second locating structures including locating recesses 106 and locating protrusions 107, which are separately arranged on the movable stopper and the handle. When the movable stopper 105 is in the stopping and avoidance positions, the locating protrusions 107 are received and located in the locating recesses 106.

In addition, the handle 100 is provided with a stopper serving as a locking rod 600. The stopper rod abuts against a trailing portion of a blade holder 310, locking the blade assembly in a folded or unfolded configuration without accidental pivoting of the blade holder 310 away.

The blade assembly is assembled to a front portion of the handle 100 through a pivotal shaft 500 so as to fold into or out of the accommodating cavity. The blade assembly includes the blade holder 310 and the blade 320, which is movably disposed on the blade holder 310. The blade holder 310 includes an outer holder member 311, an inner holder member 312 and a manipulation means 313. The outer holder member 311 acts as a mounting support and forms a working portion, together with the blade 320, while the inner holder member 312 and the manipulation means 313 constitute a translation mechanism. The inner holder member 312 is slidably disposed in the outer holder member 311, and the manipulation means 313 is coupled to the inner holder member 312 and exposed outside the outer holder member 311. Thus, the manipulation means 313 can be manipulated to actuate the inner holder member 312. The blade 320 is assembled to the inner holder member 312. Specifically, the inner holder member 312 defines a pocket 3122, and the manipulation means 313 has a stem 3131, which can be inserted into the pocket 3122 to couple the manipulation means 313 to the inner holder member 312. For ease of assembly, the outer holder member 311 includes a first holder half 3111 and a second holder half 3112, which are fastened to each other and define therebetween a mounting space for the inner holder member 312. The first holder half 3111 and second holder half 3112 define a narrow opening at their front ends, through which the blade 320 can extend out of or retract back into the outer holder member 311. The first holder half 3111 and the second holder half 3112 define in their edge lips a narrow slot 3113 extending in a forward-and-backward direction, and the second holder half 3112 defines a number of locating recesses 3114 arranged in the forward-and-backward direction of the narrow slot 3113. A shoulder 3132 of the manipulation means 313 can be located in one of the locating recesses 3114, seating the inner holder member 312 and hence the blade 320 in a corresponding position. A first resilient element 314 is disposed between the inner holder member 312 and the manipulation means 313 to bias the shoulder 3132 of the manipulation means 313 into one of the locating recesses 3114. When the manipulation means 313 is located in a frontmost one of the locating recesses 3114, the blade 320 is in an extended position. When the manipulation means 313 is located in a rearmost one of the locating recesses 3114, the blade 320 is in a retracted position.

The blade holder 310 has a fixed end and a free end. The fixed end of the blade holder 310 is arranged on the handle 100, and the free end of the blade holder 310 can pivot about the handle 100 to switch between an unfolded position and a folded position. When the blade holder 310 is in the unfolded position, the free end of the blade holder 310 is located in front of the handle 100. When the blade holder 310 is in the folded position, the free end of the blade holder 310 is received in the accommodating cavity.

Then the blade holder 310 is in the folded position, the translation mechanism can move in the lengthwise direction of the handle 100, thereby driving the blade 320 to move relative to the handle 100 between the extended position and the retracted position. When the blade 320 is in the extended position, at least part thereof extends out of the accommodating cavity from a rear end thereof. When in the retracted position, the blade 320 is received in the accommodating cavity.

The folding knife has a first working configuration, a second working configuration and a stowed configuration. When the folding knife is in the first working configuration, the blade holder 310 is in the unfolded position, and the blade 320 is partially exposed outside the blade holder 310. When the folding knife is in the second working configuration, the blade holder 310 is in the folded position, and the blade 320 is in the extended position, where it partially extends through the wide opening 104. When the folding knife is in the stowed configuration, the blade holder 310 is in the folded position, and the blade 320 is in the retracted position.

The inner holder member 312 is provided with a locking means serving as a blade lock 315. The locking means has a tongue 3151 and a force-receiving portion 3152. The blade 320 defines notches 321 in its spine. The blade 320 is attached to a left side of the inner holder member 312, with one of the notches 321 engaging the tongue 3151, and is thereby locked by the locking means against the inner holder member 312. The outer holder member 311 is provided with an unlocking means 316. When the inner holder member 312 move forwards into alignment of the locking means with the unlocking means 316, pressing the unlocking means 316 to the right can bring the unlocking means 316 into abutment with the force-receiving portion 3152 of the locking means and urge the tongue 3151 to the right away from the notch 321, unlocking the locking means 315. At this point, the blade 320 can be removed from, or loaded onto, the blade holder 310.

The locking means is pivotably assembled to the inner holder member 312, and magnetic steel 3121 is provided on the inner holder member 312. The blade 320 and the locking means are attached to the inner holder member 312 under the action of an attractive force exerted by the magnetic steel 3121. This can prevent wobbling of the blade 320 and ensure reliable locking of the blade 320 by the locking means.

With this arrangement, when the blade assembly folds into the accommodating cavity, the blade 320 can be stowed within the accommodating cavity, or extended out of the handle through the wide opening 104 of the accommodating cavity and available for use.

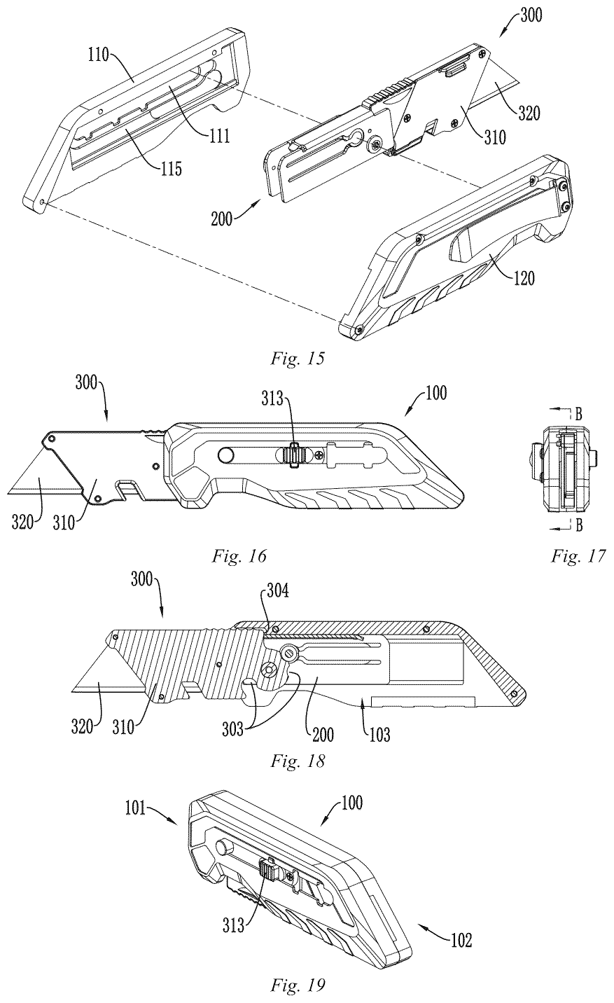

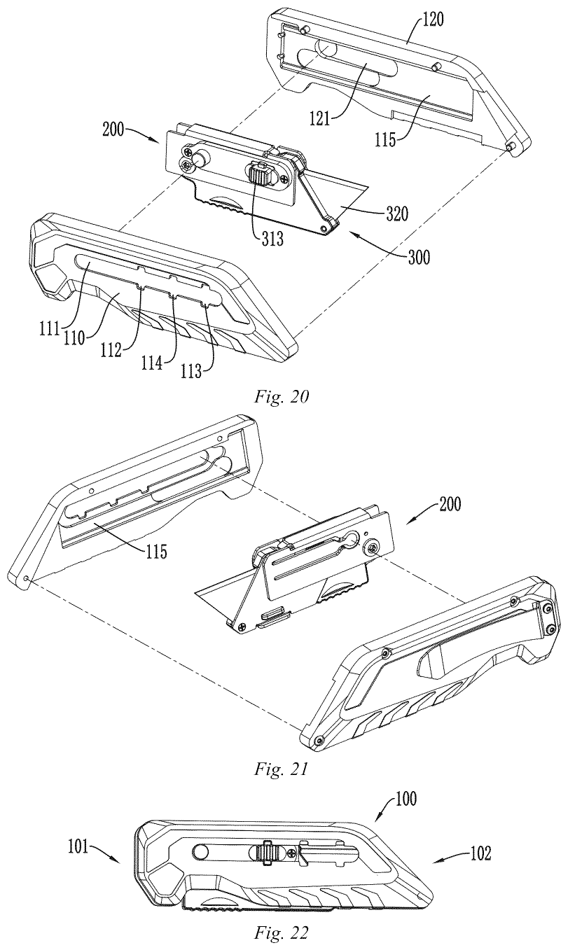

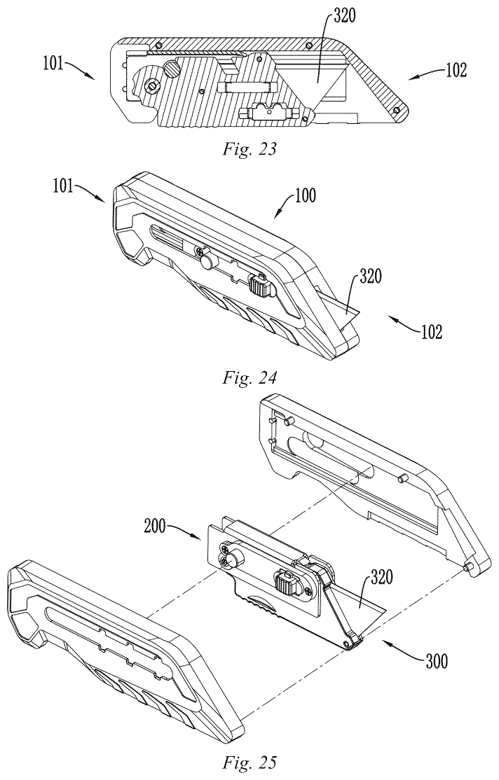

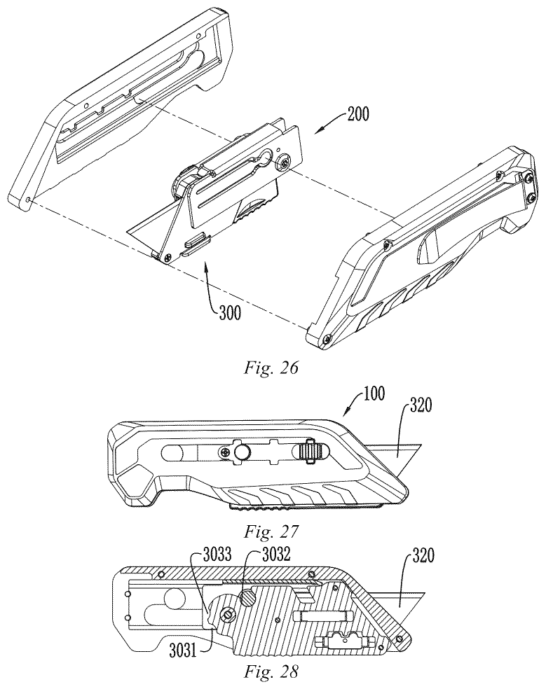

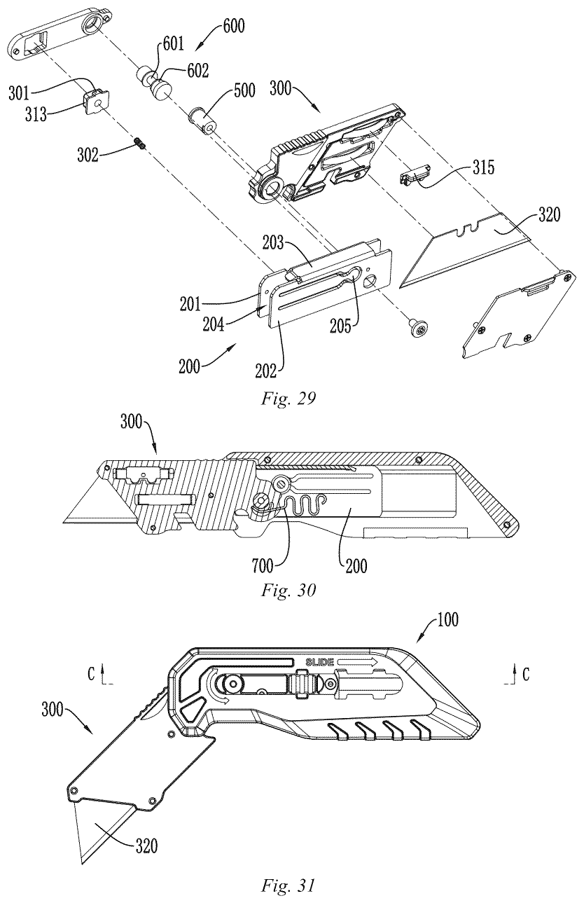

In one embodiment, as shown in FIGS. 13 to 29, a folding knife includes a handle 100, a moving member 200, a first locating structure and a cutter 300. The handle 100 serves as a grip portion.

In this embodiment, the cutter 300 is an assembly, also referred to a working portion, consisting of a blade holder 310 and a detachable blade 320. The blade holder 310 is also called a mounting support, and as part of the cutter 300, coupled to the moving member 200 by a pivotal shaft 500. In the assembly, i.e., the cutter 300, the blade 320 is locked against the blade holder 310 by a blade lock 315. In order to replace the blade 320, the blade lock 315 can be pressed to unlock the blade 300, and the blade 320 can be then removed, followed by loading of a new blade 320. In other embodiments, the detachable blade may be structured otherwise than shown. Furthermore, in other embodiments, the cutter may be an integral one-piece structure. That is, the cutter may be provided as a single component consisting of the mounting support and the blade, which are formed integrally with each other.

The handle 100 consists of first handle shell 110 and a second handle shell 120, which are coupled to each other using fasteners and define therebetween a stowing space 103. The stowing space 103 is also called an accommodating hollow and extends between a first end 101 and an opposing second end 102 of the handle 100. The first end 101 is a front end, and the second end 102 is a rear end. When the cutter 300 is in an unfolded configuration, the blade 320 is oriented towards the first end 101 of the handle 100 and away from the second end 102 of the handle 100. A lengthwise direction of the handle 100 is defined between the first end 101 and the second end 102. Inner walls of the first handle shell 110 and the second handle shell 120 define a slide channel serving as a track 115. The first handle shell 110 defines therein an elongate slot 111 extending between the first end 101 and the second end 102 and a first locating recess 112, a second locating recess 113 and a third locating recess 114, which are arranged along the elongate slot 111 sequentially from the first end 110 to the second end 120. A third position is between a first position and a second position. The handle 100 defines a wide opening 104 at the second end 120, which is surrounded on all sides and allows passage in and out therethrough.

The moving member 200 is disposed within the handle 100 and is configured to move between the first end 101 and the second end 102. Specifically, the moving member 200 includes a first side wall 201 and a second side wall 202, which are connected at their edges by a connecting feature 203 and define therebetween a compartment 204 oriented in the same way as the stowing space 103. The first side wall 201 is disposed in the slide channel in the first handle shell 110, and the second side wall 202 is disposed in the slide channel in the second handle shell 120. The compartment 204 forms part of the stowing space 103.

The moving member 200 is provided with a manipulation means 313, and the two together form a translation mechanism. The manipulation means 313 is exposed outside the handle through the elongate slot 111 and can be manipulated to drive the moving member 200 to move. As shown, the manipulation means is implemented as a push button with a bump 301. The push button is biased by a third resilient element 302 so that the bump 301 can be seated in the first locating recess 112, the second locating recess 113 or the third locating recess 114. Pressing the manipulation means 313 to urge the bump 301 out of the locating recess allows the manipulation means 313 to move in the elongate slot 111. As the moving member 200 moves with the manipulation means 313 into alignment with an intended one of the locating recesses, the manipulation means 313 can be released, allowing the third resilient element 302 to bias the manipulation means 313 to seat the bump 301 in the intended locating recess and thus locating the moving member in place.

The first locating structure can locate the blade 320 in extended and retracted positions. The first locating structure is provided on the handle 100 and the moving member 200 to locate the moving member 200, during its movement, at the first, second and third positions on the handle 100. Specifically, the first locating structure includes the first locating recess 112, the second locating recess 113, the third locating recess 114 and the manipulation means 313. When the manipulation means 313 is located in the first locating recess 112, the moving member 200 is located at the first position. When the manipulation means 313 is located in the second locating recess 113, the moving member 200 is located at the second position. When the manipulation means 313 is located in the third locating recess 114, the moving member 200 is located at the third position. When the blade holder 310 is in the folded position, the first position is the retracted position, and the second position is the extended position.

The cutter 300 is coupled between the first side wall 201 and the second side wall 202 of the moving member 200 through the pivotal shaft 500. The pivotal shaft 500 is concealed within the handle 100. With this arrangement, the cutter 300 can fold into the stowing space 103 from the unfolded configuration shown in FIGS. 13 to 18, or out of the stowing space 103 from the folded configuration shown in FIGS. 19 to 23. When the cutter 300 is in the folded configuration, the moving member 200 can be moved from the first end 101 to the second end 102 and located at the second position, and the cutter 300 can be extended out of the stowing space 103 through the second end 102 and made available for use, as shown in FIGS. 24 to 28. Alternatively, the moving member 200 can be moved from the second end 102 to the first end 101 and located at the first position, and the cutter 300 can be retracted back into the stowing space 103 through the second end 102, as shown in FIGS. 19 to 23.

The blade holder 310 has a fixed end and a free end. The fixed end of the blade holder 310 is arranged on the handle 100, and the free end of the blade holder 310 is coupled to the moving member 200. The blade 320 is mounted on the blade holder 310, with the blade 320 being partially exposed outside the blade holder 310. The free end of the blade holder 310 can pivot about the handle 100, and hence about the moving member 200, between unfolded and folded positions. When the blade holder 310 is in the unfolded position, the free end of the blade holder 310 is located in front of the handle 100. When the blade holder 310 is in the folded position, the free end of the blade holder 310 is received in the stowing space 103, more precisely, within the compartment 204.

When the blade holder 310 is in the folded position, the moving member 200 can move within the stowing space 103 in the lengthwise direction of the handle 100, causing the blade holder 310 to move relative to the handle 100 so that the blade 320 can move between the extended and retracted positions relative to the handle 100. When the blade 320 is in the extended position, at least part thereof extends out of a rear end of the stowing space 103. When the blade 320 is in the retracted position, the blade 320 is received in the stowing space 103.

The folding knife has a first working configuration, a second working configuration and a stowed configuration. When the folding knife is in the first working configuration, the blade holder 310 is in the unfolded position. When the folding knife is in the second working configuration, the blade holder 310 is in the folded position, and the blade 320 is in the extended position, wherein it partially extends through the opening that allows its passage in and out. When the folding knife is in the stowed configuration, the blade holder 310 is in the folded position, and the blade 320 is in the retracted position.

Further, the blade holder 310 of the cutter 300 defines a locking recess 303, and the moving member 200 is provided with an axially movable locking rod 600, which has a thin section 601 and a thick section 602. The locking rod 600 is switchable between a rotation-disabling position and a rotation-enabling position. The locking rod 600 is exposed outside the handle 100 through the elongate slot 111 and is therefore available for being pressed. The locking rod 600 can be biased so that the thick section 602 is located in the locking recess 303, and thereby engage in the locking recess 303, locking the cutter 300 from pivoting. When the thick section 602 is urged out of the locking recess 303 by pressing the locking rod 600 with a force overcoming the bias, the thin section 601 is aligned with the locking recess 303, and the locking rod 600 is disengaged from the locking recess 303. Consequently, the cutter 300 is unlocked and can be pivoted. The bias is provided by a resilient portion 205 of the moving member 200, and an inner end of the locking rod 600 rests in abutment with the resilient element 205. The resilient portion 205 may be formed by stamping the second side wall 202. In the illustrated implementation, there are three locking recesses 303, engaging the locking rod 600 separately in the three locking recesses 303 can lock the cutter 300 respectively in the unfolded configuration shown in FIGS. 13 to 18, the folded configuration shown in FIGS. 19 to 23 and a partially unfolded configuration between the unfolded and folded configurations. The locking recesses 303 include a first locking recess 3031, a second locking recess 3032 and a third locking recess 3033. When the blade holder 310 is in the unfolded position, the locking rod 600 engages in the first locking recess 3031. When the blade holder 310 is in the folded position, the locking rod 600 engages in the second locking recess 3032. When the blade holder 310 is in the partially unfolded position between the unfolded and folded positions, the locking rod 600 engages in the third locking recess 3033. When locked by the locking rod 600, the cutter 300 is prevented from pivoting about the pivotal shaft 500.

In this embodiment, in order to prevent erroneous operation, the cutter 300 also defines a shoulder 304. When the cutter 300 is in the unfolded configuration, the shoulder 304 is blocked by the handle 100, disallowing movement of the moving member 200 from the first position towards the second position. When the moving member 200 is moved from the first end 101 to the second end 102 and located at the second position, the folded cutter 300 extends out of the stowing space 103 through the opening and is available for use. At the same time, it is limited by the second end 102 of the handle 100 and cannot be unfolded. In other embodiments, the shoulder 304 may be omitted. In these cases, when in the unfolded configuration, the cutter 300 is not blocked and can move with the moving member 200 between the first and second positions, adjusting a length of the cutter 300 outside the handle 100.

Additionally, due to the presence of the third locating recess 114, the first locating structure can locate the moving member 200 at the third position on the handle 100 during its movement. When this happens, the folded cutter 300 is blocked by the second end 102 from folding out, and/or its length outside the second end 102 is shorter than when the moving member 200 is located at the second position on the handle 100.

Further, when the moving member 200 is located at the first position on the handle 100, the resilient portion 205 is aligned with an avoidance slot 121. This allows the resilient portion 205 to deform to such a greater extent that the locking rod 600 can axially displace adequately to unlock the cutter 300. As the moving member 300 moves towards the second end 102, the resilient portion 205 is misaligned from the avoidance slot 121, leading to limited deformability of the resilient portion 205, which does not allow the locking rod 600 to axially displace adequately to unlock the cutter 300. Therefore, only when the moving member 200 is located at the first position on the handle 100, the cutter 300 is allowed to pivot to fold in or out.

Furthermore, due to the presence of the aforementioned shoulder 304, when the cutter 300 is in the unfolded configuration, the shoulder 304 is blocked by the handle 100, disallowing the moving member 200 from moving from the first position towards the second position. After the cutter 300 folds from the first end 101 into the stowing space 103, as the shoulder 304 is not blocked any longer, the moving member 200 can be moved between the first end 101 and the second end 102.

Therefore, in this folding knife, the locking rod 600 can be manipulated to put the cutter 300 in any of the unfolded, partially unfolded and folded configurations, and to adjust the length of the cutter 300 outside the handle 100 when the cutter 300 is in the unfolded or folded configurations.

In one embodiment, as shown in FIG. 30, there is provided a folding knife, which differs from that of FIGS. 13 to 29 in additionally providing automatic unfolding by adding a fourth resilient element 700 to a cutter 300. The fourth resilient element 700 biases the cutter 300 toward an unfolded configuration, allowing it to fold out of a stowing space 103 upon being unlocked from a locking rod 600. All the other features of this embodiment are the same as those of the embodiment of FIGS. 13 to 29 and, therefore, need not be described in further detail herein.

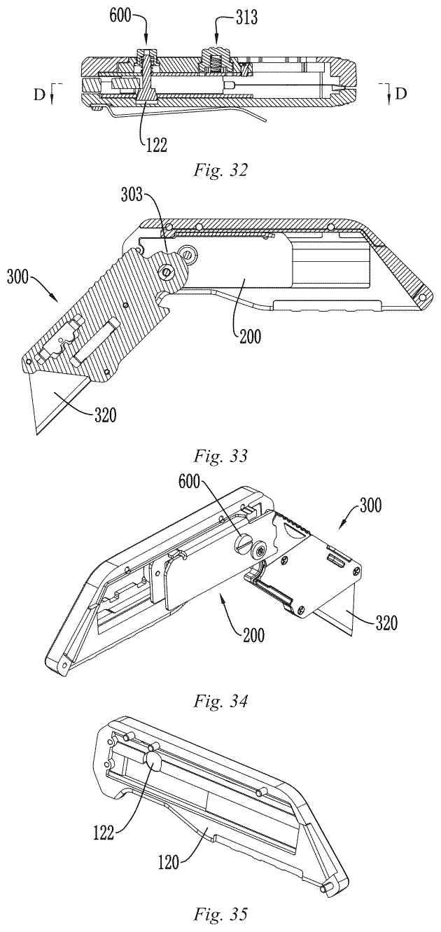

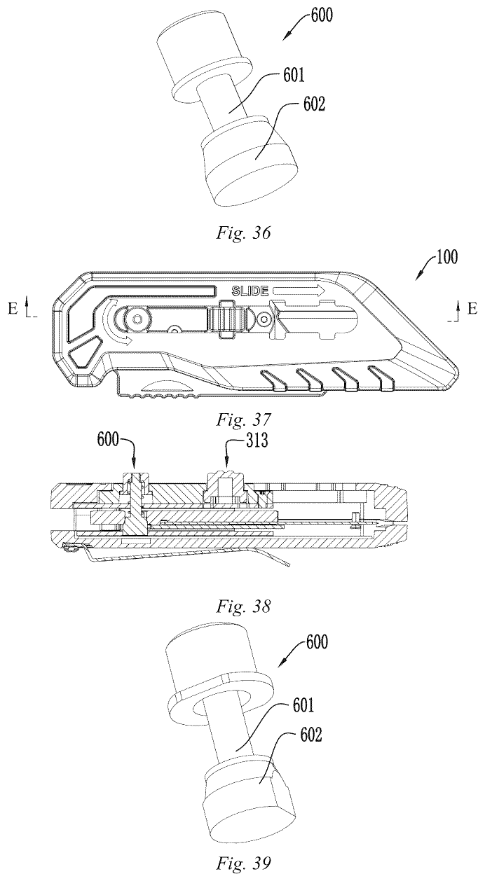

In one embodiment, as shown in FIGS. 31 to 36, there is provided a folding knife, which differs from that of FIGS. 13 to 29 in additionally providing prevention of erroneous operation. In this embodiment, a locking rod 600 is axially inserted through a moving member 200, and a second handle shell 120 defines a blind hole 122 in its inner wall. The locking rod 600 has a thin section 601 and a thick section 602. The thick section 602 has a greater diameter than the thin section 601. The thin section 601 is a cylinder, and the thick section 602 is a cylinder, a truncated cone, or a combination of both. When the thick section 602 is urged out of a locking recess 303 by pressing the locking rod 600 with a force overcoming a biasing force, the thin section 601 is aligned with the locking recess 303, and the cutter 300 is unlocked and can be pivoted. At this time, an inner end of the locking rod 600 is received in the blind hole 122, blocking the moving member 200 from movement. In particular, the blind hole 122 is located at a position where the inner end of the locking rod 600 points toward the blind hole when the moving member 200 is located at a first position. Accordingly, upon the unlocking occurring as a result of pressing the locking rod 600, the locking rod 600 moves into the blind hole 122, preventing movement of the cutter 300 with the moving member 200, which will lead to an error in operation. All the other features of this embodiment are the same as those of the embodiment of FIGS. 13 to 29 and, therefore, need not be described in further detail herein.

In one embodiment, as shown in FIGS. 37 to 39, there is provided a folding knife, which differs from that of FIGS. 31 to 36 in including a locking rod 600 having a thick section 602 in the shape of an irregular cylinder or truncated cone, which can prevent a blade 320 from suddenly pivoting away as a consequence of a locking member 600 being rotated. The thick section 602 is a cylinder or truncated cone, which has been partially cut away along its axis, or a combination of both. All the other features of this embodiment are the same as those of the embodiment of FIGS. 13 to 29 and, therefore, need not be described in further detail herein.

The foregoing embodiments are particularly configured so that pivotability of the cutter 300 and movability of the moving member 200 are mutually exclusive. That is, when the cutter 300 is able to pivot, the moving member 200 cannot move. On the contrary, when the moving member 200 is allowed to move, the cutter 300 is disallowed from pivoting. In this way, concurrence of pivoting of the cutter 300 and movement of the moving member 200, which may result in accidents, can be prevented, eliminating potential safety hazards.

It is apparent that the foregoing embodiments of the present invention are merely examples for clearly illustrating the invention, but are not intended to limit the invention to these embodiments. For those of ordinary skill in the art, many variations or modifications to the above embodiments are possible. Enumerating all possible embodiments herein is neither necessary nor possible. Any and all changes, equivalent alternatives and modifications made within the spirit and scope of the present invention are all intended to be embraced within the scope defined by the appended claims.

1. A folding knife, comprising:
a grip portion defining an accommodating hollow therein and, in a lengthwise direction thereof, a front end and a rear end;
a working portion comprising a blade and a mounting support, the blade disposed on the mounting support, the mounting support having a fixed end and a free end, the fixed end of the mounting support disposed on the grip portion, the free end of the mounting support configured to be pivotable about the grip portion to switch between an unfolded position and a folded position, wherein when the mounting support is in the unfolded position, the free end of the mounting support is located in front of the grip portion, and when the mounting support is in the folded position, the free end of the mounting support is located in the accommodating hollow;
a translation mechanism configured, when the mounting support is in the folded position, to be movable in the lengthwise direction of the grip portion, thereby driving the blade to move relative to the grip portion to switch between an extended position and a retracted position, wherein when the blade is in the extended position, at least part thereof extends out of the accommodating hollow from the rear end, and when the blade is in the retracted position, it is located in the accommodating hollow; and
a first locating structure configured to be able to locate the blade in the extended position and the retracted position.

2. The folding knife of claim 1, wherein the folding knife has a first working configuration, a second working configuration and a stowed configuration; when the folding knife is in the first working configuration, the mounting support is in the unfolded position, and the blade is partially exposed outside the mounting support; when the folding knife is in the second working configuration, the mounting support is in the folded position, and the blade is in the extended position; and when the folding knife is in the stowed configuration, the mounting support is in the folded position, and the blade is in the retracted position.

3. The folding knife of claim 2, wherein the grip portion defines at the rear end thereof a wide opening in communication with the accommodating hollow, and when the folding knife is in the second working configuration, the blade partially extends through the wide opening.

4. The folding knife of claim 3, further comprising a stopper disposed on the grip portion, the stopper configured to be movable relative to the wide opening to a stopping position, where it occludes the wide opening, confining the blade within the accommodating hollow.

5. The folding knife of claim 4, wherein the stopper and the grip portion define complementary second locating structures configured to be able to locate the stopper in the stopping position.

6. The folding knife of claim 2, wherein the translation mechanism comprises a moving member disposed within the accommodating hollow, the moving member defining a compartment, which forms part of the accommodating hollow; the fixed end of the mounting support is coupled to the moving member; the blade is mounted on the mounting support and partially exposed outside the mounting support; the free end of the mounting support is configured to be pivotable about the moving member to switch between the unfolded position and the folded position; when the mounting support is in the folded position, the free end of the mounting support is located within the compartment; and the moving member is configured to be moveable within the accommodating hollow in the lengthwise direction of the grip portion, driving the mounting support to move relative to the grip portion.

7. The folding knife of claim 6, wherein inner walls of the grip portion define a slide channel extending in the lengthwise direction of the grip portion, and the moving member is disposed in the slide channel.

8. The folding knife of claim 7, wherein the grip portion defines an elongate slot extending in the lengthwise direction of the grip portion; the first locating structure comprises a first locating recess and a second locating recess, which are arranged along the elongate slot in the lengthwise direction of the grip portion sequentially from the front backwards; the translation mechanism further comprises a manipulation means disposed on the moving member and exposed outside the grip portion through the elongate slot, the manipulation means configured to be movable in the elongate slot, driving movement of the moving member; when the manipulation means is located at the first locating recess, the moving member is in a first position; and when the manipulation means is located at the second locating recess, the moving member is in a second position.

9. The folding knife of claim 8, wherein when the mounting support is in the folded position, the first position is the retracted position, and the second position is the extended position.

10. The folding knife of claim 8, wherein the first locating structure further comprises a third locating recess located between the first locating recess and the second locating recess.

11. The folding knife of claim 8, wherein the mounting support defines locking recesses, and the moving member is provided with a locking rod exposed outside the grip portion through the elongate slot, the locking rod configured to be axially movable to switch between a rotation-disabling position and rotation-enabling position; when the locking rod is in the rotation-disabling position, the locking rod engages in one of the locking recesses, disallowing pivoting of the mounting support; and when the locking rod is in the rotation-enabling position, the locking rod disengages from the locking recess, allowing the mounting support to pivot.

12. The folding knife of claim 11, wherein the moving member defines a resilient portion; the grip portion defines an avoidance slot in its inner wall; and when the moving member is in the first position, and when the locking rod is in the rotation-enabling position, the locking rod abuts against the resilient portion, and the resilient portion is aligned with the avoidance slot.

13. The folding knife of claim 11, wherein the locking rod axially extends through the moving member; the grip portion defines a blind hole in its inner wall; and when the moving member is in the first position, the locking rod points toward the blind hole.

14. The folding knife of claim 13, wherein when the locking rod is in the rotation-enabling position, the locking rod is able to move into the blind hole, blocking the moving member from movement.

15. The folding knife of claim 11, wherein the locking recesses include a first locking recess and a second locking recess; when the mounting support is in the unfolded position, the locking rod engages in the first locking recess; and when the mounting support is in the folded position, the locking rod engages in the second locking recess.

16. The folding knife of claim 15, further comprising a resilient element disposed between the mounting support and the moving member, the resilient element configured, when the mounting support is in the folded position, and when the locking rod is in the rotation-enabling position, to be able to switch the mounting support to the unfolded position.

17. The folding knife of claim 6, wherein the mounting support defines a shoulder, which, when the mounting support is in the unfolded position, abuts against the grip portion and is configured to be able to block movement of the moving member in the lengthwise direction of the grip portion.

18. The folding knife of claim 2, wherein the translation mechanism comprises an inner holder member and a manipulation means; the inner holder member is disposed on the mounting support, and the blade is disposed on the inner holder member; and the manipulation means is coupled to the inner holder member, exposed outside the mounting support and configured to be movable in a lengthwise direction of the mounting support, thereby causing the inner holder member to move relative to the mounting support.

19. The folding knife of claim 18, wherein the first locating structure comprises a plurality of locating recesses sequentially arranged from the front backwards in the mounting support in the lengthwise direction thereof; the manipulation means is configured to be able to be located in any of the locating recesses; when the manipulation means is located in a frontmost one of the locating recesses, the blade is in the extended position; and when the manipulation means is located in a rearmost one of the locating recesses, the blade is in the retracted position.

20. The folding knife of claim 19, wherein the inner holder member is provided with a blade lock configured to be able to lock the blade against the inner holder member; the mounting support is provided with an unlocking means; and when the blade is in the extended position, the unlocking means is aligned with the blade lock and configured to be able to abut against the blade lock to disengage the blade from the inner holder member.
